(19) United States
(12) Patent Application Publication
(10) Pub. No.: US 2026/0122233 A1
(43) Pub. Date: Apr. 30, 2026

(54) ENCODING DEVICE, STREAMING SYSTEM, DECODING DEVICE, ENCODING METHOD, DECODING METHOD, AND COMPUTER PROGRAM PRODUCT

(71) Applicant: KABUSHIKI KAISHA TOSHIBA, Kawasaki-shi (JP)

(72) Inventors: Shunichi GONDO, Ota Tokyo (JP); Mika MINEMATSU, Fuchu Tokyo (JP); Yu MIZOGUCHI, Kawasaki Kanagawa (JP); Tomonori MAEGAWA, Chuo Tokyo (JP)

(73) Assignee: KABUSHIKI KAISHA TOSHIBA, Kawasaki-shi (JP)

(21) Appl. No.: 19/307,966

(22) Filed: Aug. 22, 2025

(30) Foreign Application Priority Data
Sep. 18, 2024 (JP) 2024-161041

(51) Int. Cl. H04N 19/119; H04N 19/17

(52) U.S. Cl. CPC H04N 19/119; H04N 19/17

(57) ABSTRACT

An encoding device includes one or more hardware processors configured to: receive a plurality of requests for crop zoom; set, when a plurality of first areas specified in the plurality of requests for crop zoom overlap each other, an area to be cropped from a video, to a single second area including the plurality of first areas; encode the single second area having been cropped from the video to generate encoded data; and output the encoded data.

### CROSS-REFERENCE TO RELATED APPLICATIONS

This application is based upon and claims the benefit of priority from Japanese Patent Application No. 2024-161041, filed on Sep. 18, 2024; the entire contents of which are incorporated herein by reference.

### FIELD

Embodiments described herein relate generally to an encoding device, a streaming system, a decoding device, an encoding method, a decoding method, and a computer program product.

### BACKGROUND

For example, in a macro viewpoint overhead video or the like, a conventional technique has been known to enlarge a partial area in a video by crop zoom the partial area in the video.

However, in the conventional technique, it is difficult to reduce a load on resources when a plurality of areas included in the video is enlarged.

### BRIEF DESCRIPTION OF THE DRAWINGS

FIG. 1 is a diagram illustrating an example of a device configuration of a streaming system according to an embodiment;

FIG. 2 is a diagram illustrating an example of a device configuration of an encoding device according to an embodiment;

FIG. 3 is a diagram illustrating an example of crop zoom of two areas according to an embodiment;

FIG. 4A is a diagram illustrating a first example of an adjustment process for an area to be cropped according to an embodiment;

FIG. 4B is a diagram illustrating a second example of the adjustment process for an area to be cropped according to an embodiment;

FIG. 4C is a diagram illustrating an example of non performance of the adjustment process for an area to be cropped according to an embodiment;

FIG. 4D is a diagram illustrating a third example of the adjustment process for an area to be cropped according to an embodiment;

FIG. 4E is a diagram illustrating a fourth example of the adjustment process for an area to be cropped according to an embodiment;

FIG. 5 is a diagram illustrating an example of a device configuration of a decoding device according to an embodiment;

FIG. 6A is a diagram illustrating a first example of a determination process for an area to be reproduced according to an embodiment;

FIG. 6B is a diagram illustrating a second example of the determination process for an area to be reproduced according to an embodiment;

FIG. 6C is a diagram illustrating a third example of the determination process for an area to be reproduced according to an embodiment;

FIG. 7 is a flowchart illustrating an example of an encoding method according to an embodiment;

FIG. 8 is a flowchart illustrating an example of a decoding method according to an embodiment;

FIG. 9 is a diagram illustrating an example of a device configuration of an encoding device according to a first modification of the embodiment;

FIG. 10 is a diagram illustrating an example of a device configuration of a decoding device according to a second modification of the embodiment; and

FIG. 11 is a diagram illustrating an example of a hardware configuration of each of the encoding device and the decoding device according to an embodiment.

### DETAILED DESCRIPTION

An encoding device includes one or more hardware processors configured to: receive a plurality of requests for crop zoom; set, when a plurality of first areas specified in the plurality of requests for crop zoom overlap each other, an area to be cropped from a video, to a single second area including the plurality of first areas; encode the single second area having been cropped from the video to generate encoded data; and output the encoded data.

Hereinafter, embodiments of an encoding device, a streaming system, a decoding device, an encoding method, a decoding method, and a program will be described in detail with reference to the accompanying drawings.

### Example of Device Configuration

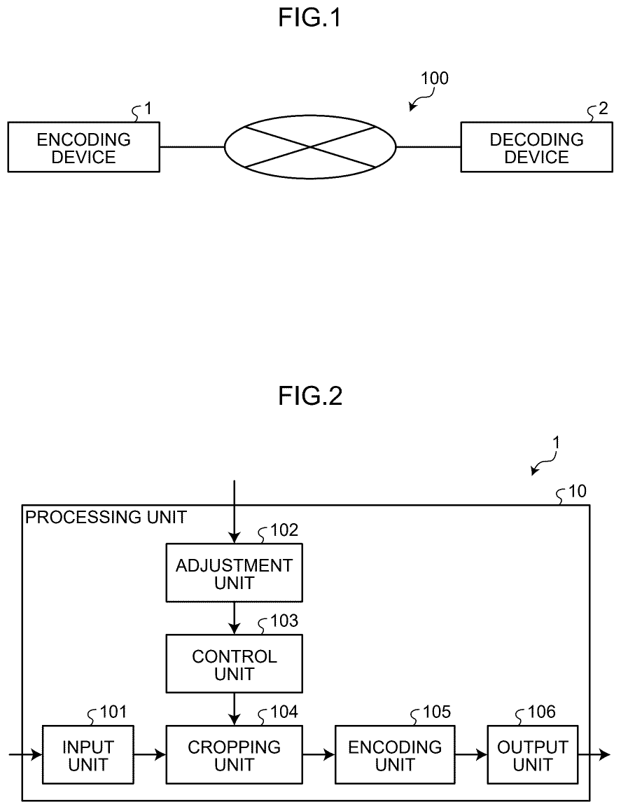

FIG. 1 is a diagram illustrating an example of a device configuration of a streaming system 100 according to an embodiment. The streaming system 100 according to the embodiment includes an encoding device 1 and a decoding device 2.

The encoding device 1 generates encoded data by encoding a video, and transmits the encoded data to the decoding device 2 via a network (e.g., the Internet or the like).

When receiving the encoded data from the encoding device 1, the decoding device 2 decodes the encoded data to output the video to a display device. In addition, the decoding device 2 transmits a request for crop zoom of the video to the encoding device 1, for enlarged display of the video.

Note that the request for crop zoom may be transmitted to the encoding device 1 from an information processing device or the like operated by a user. Furthermore, communication between the encoding device 1 and the decoding device 2 may be directly performed, or may be performed via another device such as a relay device.

### Example of Functional Configuration of Encoding Device

FIG. 2 is a diagram illustrating an example of a device configuration of the encoding device 1 according to an embodiment. The encoding device 1 according to the embodiment includes a processing unit 10.

The processing unit 10 is implemented by one or more hardware processors, and execute processing of the encoding device 1. This hardware processors include, for example, a control device and an arithmetic device, and is implemented by an analog or digital circuit or the like. The hardware processors may be a central processing unit (CPU), or may be a general-purpose processor, a microprocessor, a digital signal processor (DSP), an application specific integrated circuit (ASIC), a field-programmable gate array (FPGA), or a combination thereof.

The processing unit 10 includes an input unit 101, an adjustment unit 102, a control unit 103, a cropping unit 104, an encoding unit 105, and an output unit 106.

The input unit 101 receives an input of a video captured by an image capturing device or the like. For example, the video is an overhead video with a 4K resolution (3,840×2,160 pixels) or the like.

When receiving the request for crop zoom of the video, from the decoding device 2, the adjustment unit 102 adjusts an area to be cropped from the video.

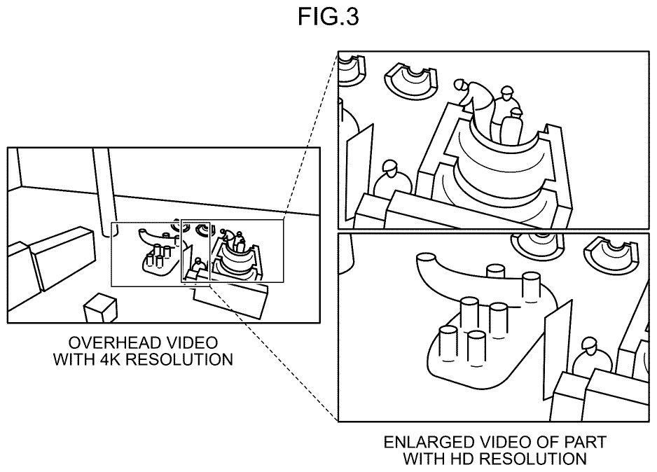

FIG. 3 is a diagram illustrating an example of crop zoom of two areas according to an embodiment. The example of FIG. 3 illustrates an enlarged display by cropping a part of a 4K camera video. With the camera that captures the video has the 4K resolution, for example, cropping of a video of HD resolution, as illustrated in FIG. 3, enables an effect the same as that of enlargement zoom.

The crop zoom is performed by, for example, interactive zooming that receives dynamic specification of a cropping position from the decoding device 2. In the interactive zooming or the like, it is required to suppress a load under resource constraints such as performance of a computer that implements the encoding device 1 and the decoding device 2, and a communication band.

For example, when the requests for crop zoom of different areas are received from a plurality of users, loads such as video compression processing and a transmission data volume are applied, if the respective areas are cropped, encoded, and distributed according to the requests of the users.

Furthermore, for example, when the request for crop zoom of a plurality of different areas are received from one user, loads such as the video compression processing and the transmission data volume are similarly applied.

Note that it is also considered to generate the encoded data by cropping and encoding a plurality of areas in advance to distribute the encoded data in response to the request. However, necessity of a high-performance computer, and restriction in the number of areas processed in advance due to restriction on the load of the video compression processing do not always enable cropping of the areas satisfying the request of the user.

Therefore, when receiving the request for crop zoom of a plurality of different areas, the adjustment unit 102 of the present embodiment adjusts an area to be cropped from the video. Details of an adjustment process for the area to be cropped will be described later.

Returning to FIG. 2, the control unit 103 controls a cropping process for the area to be cropped, adjusted by the adjustment unit.

The cropping unit 104 crops the area to be cropped from the video under the control of the control unit 103, and inputs the cropped area to the encoding unit 105. Note that when there is not an area cropping instruction from the control unit 103, the cropping unit 104 directly inputs the video input from the input unit 101 to the encoding unit 105.

The encoding unit 105 encodes the video or the area cropped from the video to generate encoded data. The encoding unit 105 inputs the encoded data to the output unit 106.

The output unit 106 outputs the encoded data input from the encoding unit 105. The encoded data output from the output unit 106 is received by the decoding device 2 via the network.

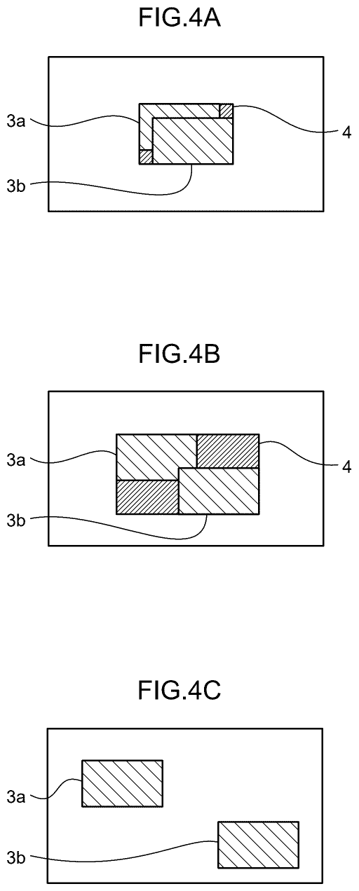

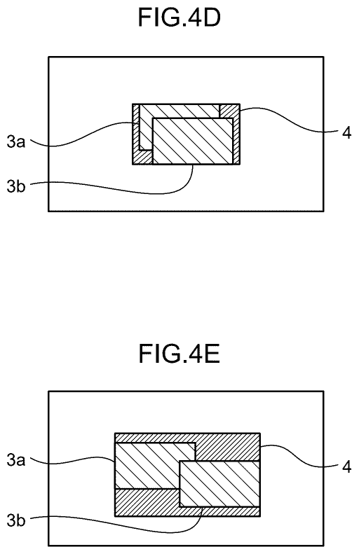

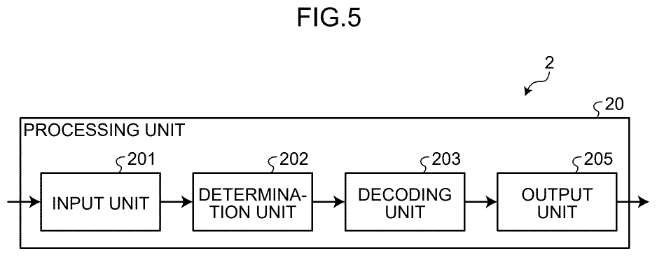

FIG. 4A is a diagram illustrating a first example of an adjustment process for an area to be cropped according to an embodiment. When a plurality of areas (first areas) to be cropped specified by the user overlaps, the adjustment unit 102 unifies areas 3a and 3b to be cropped/zoomed, for example, as illustrated in FIG. 4A, and adjusts the area to be cropped to crop a single area 4 (second area) to be cropped.

FIG. 4B is a diagram illustrating a second example of the adjustment process for an area to be cropped according to an embodiment. When a plurality of areas (first areas) to be cropped specified by the user overlaps, the adjustment unit 102 unifies the areas 3a and 3b to be cropped/zoomed, for example, as illustrated in FIG. 4B, and adjusts the area to be cropped to crop a single area 4 (second area) to be cropped.

In other words, in the examples of FIGS. 4A and 4B, the adjustment unit 102 adjusts an aspect ratio of the second area such that the second area includes the plurality of first areas and has a further smaller size.

FIG. 4C is a diagram illustrating an example of non performance of the adjustment process for an area to be cropped according to an embodiment. When the plurality of areas 3a and 3b to be cropped specified by the user do not overlap, the adjustment unit 102 does not perform adjustment for unifying the areas 3a and 3b to be cropped/zoomed.

FIGS. 4D and 4E are diagrams illustrating third and fourth examples of the adjustment process for an area to be cropped according to embodiments. When a plurality of areas (first areas) to be cropped specified by the user overlaps, the adjustment unit 102 unifies the areas 3a and 3b to be cropped/zoomed, for example, as illustrated in FIGS. 4D and 4E, and adjusts the area to be cropped to crop a single area 4 (second area) to be cropped.

The examples of FIGS. 4D and 4E are different from the examples of FIGS. 4A and 4B described above in that the area 4 to be cropped has a predetermined aspect ratio. When areas 3a and 3b are unified as illustrated in FIGS. 4A and 4B described above, a special aspect ratio that is not general may be obtained. For example, the predetermined aspect ratio is an aspect ratio used in the encoding device 1 and decoding device 2 that are used in general. Specifically, the predetermined aspect ratio is an aspect ratio standardized by the Moving Picture Experts Group (MPEG) or the like.

In the examples of FIGS. 4D and E, when the areas 3a and 3b to be cropped/zoomed are unified, the adjustment unit 102 performs adjustment to the predetermined aspect ratio, and therefore, even the encoding device 1 and decoding device 2 that are used in general facilitates processing of the unified area 4 without special processing.

In other words, in the examples of FIGS. 4D and 4E, the adjustment unit 102 adjusts the aspect ratio of the second area such that the second area includes the plurality of first areas and has the predetermined aspect ratio.

Note that, in the examples of FIGS. 4D and E, the unified area 4 is extended to have the predetermined aspect ratio, and therefore, the size of the unified area 4 is larger than those of FIGS. 4A and 4B described above. Therefore, from the viewpoint of reduction in data volume, FIGS. 4A and 4B are better than FIGS. 4D and E.

For example, whether to extend the unified area 4 to the predetermined aspect ratio may be changeable in settings.

Furthermore, for example, whether to reduce the size (resize) of the unified area 4 may be changeable in settings. In the processing of reducing the size of the unified area 4, for example, processing of reducing the resolution to 720 p is performed.

Note that, the examples of FIGS. 4A to 4E described above shows the two areas to be cropped specified by the user, but the adjustment process for three or more areas to be cropped specified by the user is also similar to the adjustment process described above with reference to FIGS. 4A to 4E.

### Example of Functional Configuration of Decoding Device

FIG. 5 is a diagram illustrating an example of a device configuration of the decoding device 2 according to an embodiment. The decoding device 2 of the embodiment includes a processing unit 20.

The processing unit 20 is implemented by one or more hardware processors, and execute processing of the decoding device 2. The hardware processors are similar to the processing unit 10 (FIG. 2) of the encoding device 1, and the description thereof will not be repeated.

The processing unit 20 includes an input unit 201, a determination unit 202, a decoding unit 203, and an output unit 205. Note that a functional configuration of the processing unit 20 is an example, and may be changed as appropriate. In a second modification of the embodiment described later, a configuration (FIG. 10) including a display control unit 204 instead of the determination unit 202 will be described.

The input unit 201 receives an input of the encoded data transmitted from the encoding device 1 via the network.

The determination unit 202 transmits a plurality of requests for crop zoom of the video generated on the basis of the encoded data transmitted from the encoding device 1. Furthermore, the determination unit 202 determines an area to be reproduced, when receiving a response according to the request for crop zoom of the video, from the decoding device 2. Details of determination process for the area to be reproduced will be described later.

The decoding unit 203 decodes the video or the area cropped from the video to generate the video. The decoding unit 203 inputs the decoded video to the output unit 106.

The output unit 205 outputs the video input from the decoding unit 203. The video output from the output unit 106 is displayed by the display device.

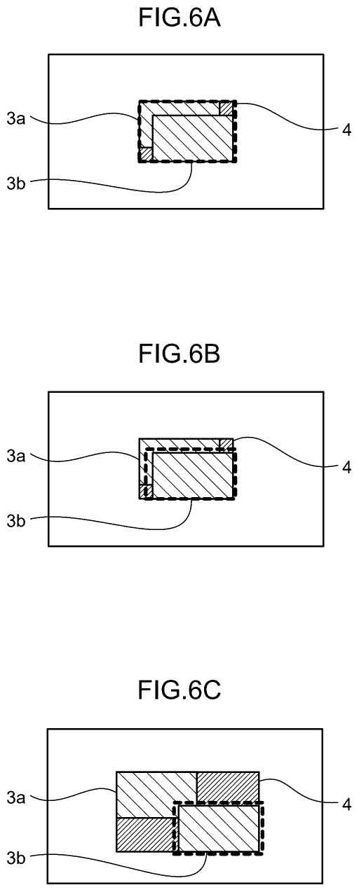

FIG. 6A is a diagram illustrating a first example of a determination process for an area to be reproduced according to an embodiment. For example, the determination unit 202 determines to directly reproduce the area 4 (second area) set by the adjustment process described above by the encoding device 1, instead of two areas 3a and 3b (two first areas) specified in the requests for crop zoom.

FIGS. 6B and 6C are diagrams illustrating second and third examples of the determination process for an area to be reproduced according to embodiments. For example, the determination unit 202 determines to separately reproduce the two areas 3a and 3b (two first areas) specified in the requests for crop zoom, according to operation inputs for specifying areas to be reproduced or the like. FIGS. 6B and 6C each illustrate an example of the area to be reproduced when the area 3b specified in the request for crop zoom is reproduced.

Note that the determination unit 202 may determine the area to be reproduced according to specification from the encoding unit 105 of the encoding device 1. For example, the input unit 201 receives an input of the encoded data of a video including the second area described above. The determination unit 202 determines an area to be decoded from which the video of the second area specified by the encoding device 1 is output. The decoding unit 203 decodes the area to be decoded determined by the determination unit 202. Then, the output unit 205 outputs the video of the second area.

### Example of Encoding Method

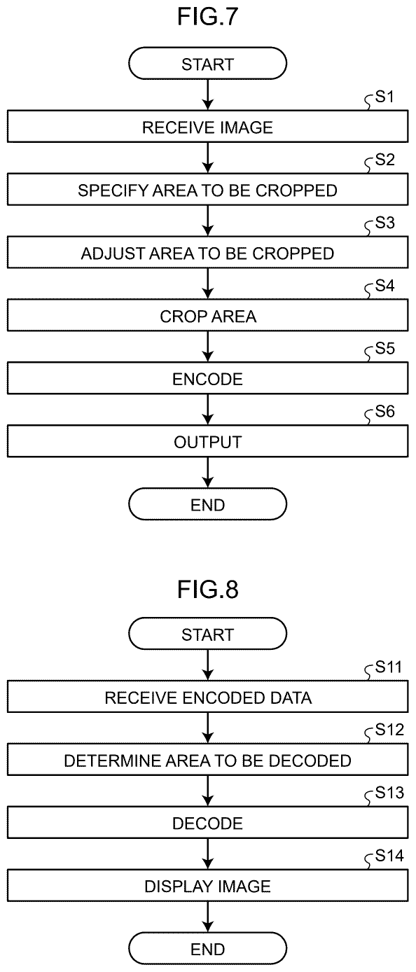

FIG. 7 is a flowchart illustrating an example of the encoding method according to an embodiment. First, the input unit 101 receives an input of a video (image) captured by the image capturing device or the like (Step S1).

Next, the adjustment unit 102 receives the request for crop zoom of the video from the decoding device 2 to receive the specification of the area to be cropped (Step S2). Next, the adjustment unit 102 adjusts the area to be cropped from the video by the adjustment process described above (Step S3).

Next, under the control of the control unit 103, the cropping unit 104 crops the area to be cropped adjusted in Step S3, from the video (Step S4). Next, the encoding unit 105 encodes the area having been cropped from the video by the processing of Step S4 (Step S5). Next, the output unit 106 outputs the encoded data having been encoded in Step S5 (Step S6).

### Example of Decoding Method

FIG. 8 is a flowchart illustrating an example of the decoding method according to an embodiment. First, the input unit 201 receives, via the network, an input of the encoded data transmitted from the encoding device 1, as a response to the request for crop zoom of the video (Step S11).

Next, the determination unit 202 determines the area to be decoded by the determination process described above (Step S12). Next, the decoding unit 203 decodes the area to be decoded determined in Step S12 (Step S13).

Next, the output unit 205 outputs a video (image) decoded in Step S13 to the display device, for display of the video (image) (Step S14).

As described above, in the encoding device 1 of the embodiment, the input unit 101 receives a plurality of requests for crop zoom. When the first areas specified in the plurality of requests for crop zoom overlap each other, the adjustment unit 102 sets the area to be cropped from the video, to a single second area including the plurality of first areas. The encoding unit 105 encodes the single second area having been cropped from the video to generate the encoded data. Then, the output unit 106 outputs the encoded data.

Furthermore, in the decoding device 2 of the embodiment, the determination unit 202 transmits the plurality of requests for crop zoom of the video generated on the basis of the encoded data transmitted from the encoding device 1. When the first areas specified in the plurality of requests for crop zoom overlap each other, the input unit 201 receives an input of the encoded data of the single second area including the plurality of first areas. Then, the decoding unit 203 and the output unit 205 output a video generated by decoding the encoded data.

According to the streaming system 100 of the embodiment, it is possible to reduce the load on the resources when the plurality of areas included in the video is enlarged.

### First Modification of Embodiment

Next, a first modification of the embodiment will be described. In the description of the first modification, a description similar to that of the embodiment will not be repeated, and a description of a difference from the embodiment will be made.

### Example of Functional Configuration of Encoding Device

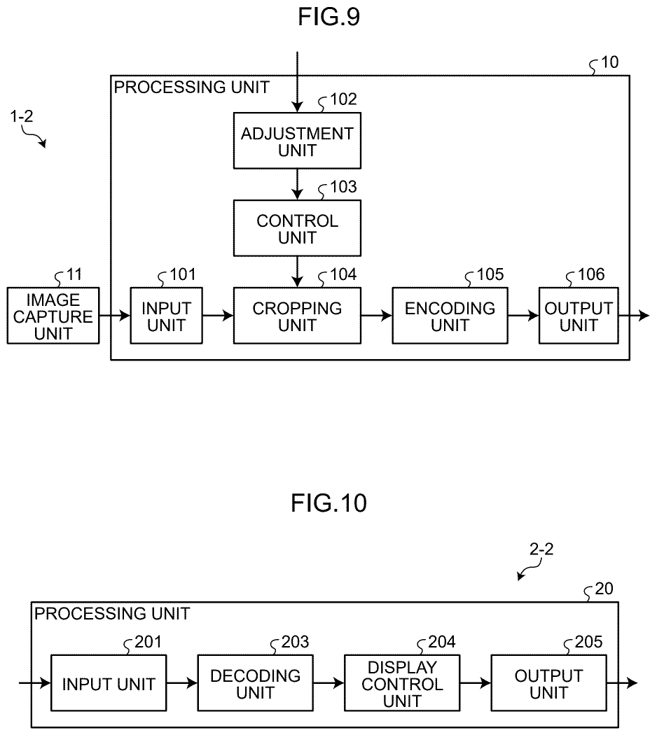

FIG. 9 is a diagram illustrating an example of a device configuration of an encoding device 1-2 according to a first modification of the embodiment. The encoding device 1-2 of the first modification includes the processing unit 10 and an image capture unit 11. In the first modification, the image capture unit 11 is further added to the configuration (FIG. 2) of the above embodiment.

The image capture unit 11 is, for example, a camera that captures a 4K video (image). As illustrated in FIG. 9, the encoding device 1-2 may include the image capture unit 11.

### Second Modification of Embodiment

Next, the second modification of the embodiment will be described. In the description of the second modification, a description similar to that of the embodiment will not be repeated, and a description of a difference from the embodiment will be made.

### Example of Functional Configuration of Decoding Device

FIG. 10 is a diagram illustrating an example of a device configuration of a decoding device 2-2 according to the second modification of the embodiment. The decoding device 2-2 of the second modification includes the processing unit 20.

The processing unit 20 includes the input unit 201, the decoding unit 203, the display control unit 204, and the output unit 205. In other words, in the second modification, the display control unit 204 is provided instead of the determination unit 202.

The input unit 201 receives inputs of the encoded data of the video including the second area described above and specification information (i.e., information to specify the second area) specifying the area to be reproduced. The second area includes a plurality of the first areas, and is generated by the encoding device 1 when the first areas specified in the plurality of requests for crop zoom overlap each other.

The decoding unit 203 decodes the encoded data to generate a video.

The display control unit 204 performs control to output a video of the second area specified by the specification information in the video generated by decoding the encoded data, to the output unit 205.

### Third Modification of Embodiment

Next, a third modification of the embodiment will be described. In the description of the third modification, a description similar to that of the embodiment will not be repeated, and a description of a difference from the embodiment will be made.

An example of a functional configuration of an encoding device 3 of the third modification is similar to the functional configuration of the encoding device 1 of the embodiment, and thus will be described with reference to FIG. 2.

In the third modification, the cropping unit 104 crops a plurality of third areas specified in advance, from a video. In other words, in the third modification, the second area described above is not dynamically determined in response to the plurality of requests for crop zoom, but any of the plurality of third areas specified in advance is determined.

Furthermore, the encoding unit 105 sets generation processing of encoded data of the plurality of third areas included in the video to be startable. Specifically, parameters (e.g., specification of position and size of each of the plurality of third areas, specification of encoding system, and the like) used for encoding are set in advance so that the encoding can be started immediately.

When receiving the plurality of requests for crop zoom, from the decoding device 2, the encoding unit 105 starts the generation processing of encoded data of a single third area including a plurality of first areas, when the first areas specified in the requests for crop zoom overlap each other, thereby generating the encoded data. Then, the output unit 106 outputs the encoded data of the third area.

As in the third modification of the embodiment, the plurality of third areas may be cropped in advance, encoding of each of the third areas may be set to be startable, and the single third area including the plurality of first areas may be processed when the first areas specified in the plurality of requests for crop zoom.

Finally, an example of a hardware configuration of each of the encoding device 1 and the decoding device 2 according to an embodiment will be described.

### Example of Hardware Configuration

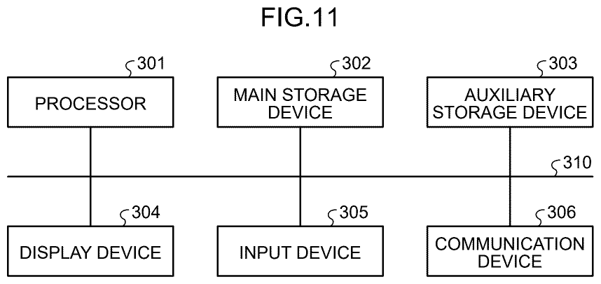

FIG. 11 is a diagram illustrating an example of a hardware configuration of each of the encoding device 1 and the decoding device 2 according to an embodiment. The encoding device 1 and the decoding device 2 of the embodiment each include a processor 301, a main storage device 302, an auxiliary storage device 303, a display device 304, an input device 305, and a communication device 306. The processor 301, the main storage device 302, the auxiliary storage device 303, the display device 304, the input device 305, and the communication device 306 are connected via a bus 310.

Note that the encoding device 1 and the decoding device 2 may not include part of the above configuration. For example, when the encoding device 1 and the decoding device 2 are each configured to use an input function and a display function of an external device, the display device 304 and the input device 305 may not be provided in each of the encoding device 1 and the decoding device 2.

The processor 301 executes a program read from the auxiliary storage device 303 into the main storage device 302. The main storage device 302 is a memory such as ROM and RAM. The auxiliary storage device 303 is a hard disk drive (HDD), a memory card, or the like.

The display device 304 is, for example, a liquid crystal display or the like. The input device 305 is an interface for operating each of the encoding device 1 and the decoding device 2. Note that the display device 304 and the input device 305 may be implemented by a touch screen or the like having a display function and an input function. The communication device 306 is an interface for communicating with another device.

For example, a program executed in each of the encoding device 1 and the decoding device 2 is recorded in a computer-readable storage medium such as a memory card, a hard disk, a CD-RW, a CD-ROM, a CD-R, a DVD-RAM, and a DVD-R, in an installable format or executable format, and is provided as a computer program product.

Furthermore, the program executed in each of the encoding device 1 and the decoding device 2 may be configured to be stored on a computer connected to the network such as the Internet so as to be provided by being downloaded via the network.

Furthermore, the program executed in each of the encoding device 1 and the decoding device 2 may be provided via the network, such as the Internet, instead of being downloaded. Specifically, processing may be executed by a so-called application service provider (ASP) service that implements a processing function only through an execution instruction for the program and result acquisition thereof, without transferring the program from a server computer.

Furthermore, for example, the program of each of the encoding device 1 and the decoding device 2 may be provided by being stored in the ROM or the like in advance.

The programs executed in the encoding device 1 and the decoding device 2 have module configurations including functions of the functional configurations described above that can also be implemented by the programs. As actual hardware, in each of the functions, the processor 301 reads a program from the storage medium and executes the program, and each of the functional blocks is loaded into the main storage device 302. In other words, each of the functional blocks is generated in the main storage device 302.

Note that part or all of the functional blocks described above may be implemented by hardware, such as an integrated circuit (IC), not by software.

Furthermore, a plurality of the processors 301 may be used to implement the respective functions, and in that case, each of the processors 301 may implement one of the functions or implement two or more of the functions.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

### Supplementary Note

Note that the above embodiments can be summarized in the following Technical Ideas:

### Technical Idea 1

An encoding device comprising
a processing unit configured to:
   receive a plurality of requests for crop zoom;
   set, when a plurality of first areas specified in the plurality of requests for crop zoom overlap each other, an area to be cropped from a video, to a single second area including the plurality of first areas;
   encode the single second area having been cropped from the video to generate encoded data; and
   output the encoded data.

### Technical Idea 2

The encoding device according to Technical Idea 1, wherein
the processing unit is configured to adjust an aspect ratio of the second area such that the second area includes a plurality of the first areas and has a smaller size.

### Technical Idea 3

The encoding device according to Technical Idea 1, wherein
the processing unit is configured to adjust an aspect ratio of the second area such that the second area includes a plurality of the first areas and has a predetermined aspect ratio.

### Technical Idea 4

The encoding device according to any one of Technical Ideas 1 to 3, wherein
the processing unit is configured to set generation processing of encoded data of a plurality of third areas included in the video to be startable, and
when receiving the plurality of requests for crop zoom,
start the generation processing of encoded data of a single third area, as the second area, including a plurality of the first areas, when the first areas specified in the plurality of requests for crop zoom overlap each other, and output the encoded data of the third area.

### Technical Idea 5

The encoding device according to any one of Technical Ideas 1 to 4, further comprising
an image capture unit configured to capture the video.

### Technical Idea 6

A streaming system comprising:
the encoding device according to any of Technical Ideas 1 to 5; and
a decoding device,
wherein the decoding device includes a processing unit configured to receive an input of the encoded data transmitted from the encoding device directly or via another device, and output a video generated by decoding the encoded data.

### Technical Idea 7

A decoding device comprising
a processing unit configured to:
   transmit a plurality of requests for crop zoom of a video based on encoded data transmitted from an encoding device;
   receive, when a plurality of first areas specified in the plurality of requests for crop zoom overlap each other, an input of encoded data of a single second area including the plurality of first areas; and
   output a video generated by decoding the encoded data.

### Technical Idea 8

The decoding device according to Technical Idea 7, wherein
the processing unit is configured to output a video of the second area.

### Technical Idea 9

The decoding device according to Technical Idea 7 or 8, wherein
the processing unit is configured to determine any of the plurality of first areas included in the second area, as an area to be reproduced, and output a video of the area to be reproduced.

### Technical Idea 10

The decoding device according to any one of Technical Ideas 7 to 9, wherein
the processing unit is configured to receive an input of encoded data of a video including the second area and specification information to specify the second area, and
output a video of the second area specified by the specification information in the video generated by decoding the encoded data.

### Technical Idea 11

An encoding method comprising:
receiving a plurality of requests for crop zoom, by an encoding device;
when a plurality of first areas specified in the plurality of requests for crop zoom overlap each other, an area to be cropped from a video, to a single second area including the plurality of first areas, by the encoding device setting; and
encoding the single second area having been cropped from the video to generate encoded data, by the encoding device; and
outputting the encoded data, by the encoding device.

### Technical Idea 12

A decoding method comprising:
transmitting a plurality of requests for crop zoom of a video based on encoded data transmitted from an encoding device, by a decoding device;
receiving, when a plurality of first areas specified in the plurality of requests for crop zoom overlap each other, an input of encoded data of a single second area including the plurality of first areas, by the decoding device; and
outputting a video generated by decoding the encoded data, by the decoding device.

### Technical Idea 13

A program causing a computer to execute:
receiving a plurality of requests for crop zoom;
setting, when a plurality of first areas specified in the plurality of requests for crop zoom overlap each other, an area to be cropped from a video, to a single second area including the plurality of first areas; and
encoding the single second area having been cropped from the video to generate encoded data; and
outputting the encoded data.

### Technical Idea 14

A program causing a computer to execute:
transmitting a plurality of requests for crop zoom of a video based on encoded data transmitted from an encoding device;
receiving, when a plurality of first areas specified in the plurality of requests for crop zoom overlap each other, an input of encoded data of a single second area including the plurality of first areas; and
outputting a video generated by decoding the encoded data.

What is claimed is:

1. An encoding device comprising
one or more hardware processors configured to:
receive a plurality of requests for crop zoom;
set, when a plurality of first areas specified in the plurality of requests for crop zoom overlap each other, an area to be cropped from a video, to a single second area including the plurality of first areas;
encode the single second area having been cropped from the video to generate encoded data; and
output the encoded data.

2. The device according to claim 1, wherein
the one or more hardware processors are configured to adjust an aspect ratio of the second area such that the second area includes a plurality of the first areas and has a smaller size.

3. The device according to claim 1, wherein
the one or more hardware processors are configured to adjust an aspect ratio of the second area such that the second area includes a plurality of the first areas and has a predetermined aspect ratio.

4. The device according to claim 1, wherein
the one or more hardware processors are configured to set generation processing of encoded data of a plurality of third areas included in the video to be startable, and
when receiving the plurality of requests for crop zoom,
start the generation processing of encoded data of a single third area, as the second area, including a plurality of the first areas, when the first areas specified in the plurality of requests for crop zoom overlap each other, and output the encoded data of the third area.

5. The device according to claim 1, further comprising an imager configured to capture the video.

6. A streaming system comprising:
the encoding device according to claim 1; and
a decoding device,
wherein the decoding device includes one or more hardware processors configured to receive an input of the encoded data transmitted from the encoding device directly or via another device, and output a video generated by decoding the encoded data.

7. A decoding device comprising
one or more hardware processors configured to:
transmit a plurality of requests for crop zoom of a video based on encoded data transmitted from an encoding device;
receive, when a plurality of first areas specified in the plurality of requests for crop zoom overlap each other, an input of encoded data of a single second area including the plurality of first areas; and
output a video generated by decoding the encoded data.

8. The device according to claim 7, wherein
the one or more hardware processors are configured to output a video of the second area.

9. The device according to claim 7, wherein
the one or more hardware processors are configured to determine any of the plurality of first areas included in the second area, as an area to be reproduced, and output a video of the area to be reproduced.

10. The device according to claim 7, wherein
the one or more hardware processors are configured to receive an input of encoded data of a video including the second area and specification information to specify the second area, and
output a video of the second area specified by the specification information in the video generated by decoding the encoded data.

11. An encoding method comprising:
receiving a plurality of requests for crop zoom, by an encoding device;
when a plurality of first areas specified in the plurality of requests for crop zoom overlap each other, an area to be cropped from a video, to a single second area including the plurality of first areas, by the encoding device setting; and
encoding the single second area having been cropped from the video to generate encoded data, by the encoding device; and
outputting the encoded data, by the encoding device.

12. A decoding method comprising:
transmitting a plurality of requests for crop zoom of a video based on encoded data transmitted from an encoding device, by a decoding device;
receiving, when a plurality of first areas specified in the plurality of requests for crop zoom overlap each other, an input of encoded data of a single second area including the plurality of first areas, by the decoding device; and
outputting a video generated by decoding the encoded data, by the decoding device.

13. A computer program product comprising a non-transitory computer-readable medium including programmed instructions, the instructions causing a computer to execute:
receiving a plurality of requests for crop zoom;
setting, when a plurality of first areas specified in the plurality of requests for crop zoom overlap each other, an area to be cropped from a video, to a single second area including the plurality of first areas; and
encoding the single second area having been cropped from the video to generate encoded data; and
outputting the encoded data.

14. A computer program product comprising a non-transitory computer-readable medium including programmed instructions, the instructions causing a computer to execute:
transmitting a plurality of requests for crop zoom of a video based on encoded data transmitted from an encoding device;
receiving, when a plurality of first areas specified in the plurality of requests for crop zoom overlap each other, an input of encoded data of a single second area including the plurality of first areas; and
outputting a video generated by decoding the encoded data.
